(19) United States
(12) Patent Application Publication
(10) Pub. No.: US 2002/0148555 A1
(43) Pub. Date: Oct. 17, 2002

(54) Method of cutting and sealing material

(75) Inventor: Robert B. Vigder, Dayton, OH (US)

Correspondence Address: BIEBEL & FRENCH, 35 EAST FIRST STREET, DAYTON, OH, 45402

(73) Assignee: Omega International, Dayton, OH

(21) Appl. No.: 10/119,986

(22) Filed: Apr. 10, 2002

Related U.S. Application Data
(60) Provisional application No. 60/284,120, filed on Apr. 16, 2001.

(51) Int. Cl. B32B 31/00

(52) U.S. Cl. 156/250

(57) ABSTRACT

A method of cutting and sealing material including providing a cutting and sealing rule defining a cutting edge and a sealing surface, and providing a cooperating anvil member adjacent to the cutting and sealing rule. A material having at least two layers is provided located between the anvil member and the cutting and sealing rule. The cutting and sealing rule includes a cutting blade edge and a sealing surface extending transversely to a plane of the cutting blade edge. The cutting and sealing rule is brought into engagement with the material to be cut whereby the material is simultaneously cut and sealed along an edge adjacent the cut as a result of compressive force applied to the material at the cut edge.

### BACKGROUND OF THE INVENTION

1. Field of the Invention

The present invention relates generally to a method for cutting and sealing the edges of material and, more particularly, to a method for simultaneously cutting and sealing edges of fibrous material in order to seal an inner layer of material between two outer layers.

2. Related Prior Art

The manufacture of products from polymeric materials, such as products for forming insulating panels, is commonly performed by a die cutting operation in which the cut edges of the polymeric material must be sealed. The objectives of performing the sealing operation includes prevention of the fibrous strands of the material from adhering to the cut edges, and providing a seal between two outer material layers in order to seal an inner layer of material therein.

At present, the sealing of the die cut edges has been accomplished by one of the following methods: 1) thermal die cutting on a flatbed die cutter equipped with a heated metal platen and a flat die board containing conventionally beveled steel cutting rule; 2) thermal die cutting on a steel-to-steel rotary die cutter equipped with a heated machine steel rotary die cylinder and a steel rotary anvil cutting cylinder; and 3) die cutting and sealing with an ultrasonic cutting machine.

Each of the noted methods produces results that are less than desirable for one or more of the following reasons: 1) inability to provide an effective seal on an acceptable percentage of the cut edge; 2) very slow production rates, either as a result of the particular die cutting method used or to accommodate a thermal sealing operation; 3) unacceptably high die costs; 4) unacceptably high equipment costs, including increased equipment costs for thermal sealing components; and 5) high energy costs, such as are associated with a thermal sealing operation.

Further, in many prior art systems incorporating input of thermal energy to form a bond between two layers of material, an intermediate layer of material or additional material coating having thermal sensitive properties is provided interiorly of the two layers to be joined together wherein the intermediate material is melted by the application of heat to form an adhesive between the two joined material layers.

Accordingly, there is a need for a method of die cutting shapes from sheets or continuous webs of material that result in a finished product with clean cut and sealed edges. There is a further need for a method of die cutting and edge sealing material on a variety of machines, including soft anvil rotary and reciprocating flatbed die cutting machines that is significantly faster, less labor intensive, and which requires less energy than other methods available for producing the same end product.

### SUMMARY OF THE INVENTION

The present invention provides a method of cutting and sealing material wherein the method includes providing a cutting and sealing rule defining a cutting edge and a sealing surface, providing an anvil member adjacent and in facing relation to the cutting and sealing rule, providing a material having at least two layers, positioning the material between the cutting and sealing rule and the anvil member, and operating the cutting and sealing rule to cut and seal the material to form a cut material edge and to compress the layers of material to cause the layers to adhere to each other and form a sealed edge at the cut material edge.

In a further aspect of the method, the anvil member includes a compressible surface material and the cutting edge of the cutting and sealing rule engages the compressible surface material during cutting of the material.

In another aspect of the invention, the sealed edge is created by energy derived from movement of the cutting and sealing rule relative to the anvil member.

Additional aspects of the invention include providing the sealed edge as a continuous seal formed along the length of the cut edge simultaneously with cutting of the edge, and further that the sealed edge defines a boundary between the cut edge and an area of the two layers which are unattached to each other.

In yet a further aspect of the invention, the material comprises a blown filament polypropylene insulation material comprising opposing surface layers formed of polypropylene scrim and a panel of polypropylene fibers therebetween.

### BRIEF DESCRIPTION OF THE DRAWINGS

FIG. 1 is a schematic side elevational view of a soft anvil rotary die cutter which may be used for carrying out the method of the present invention;

FIG. 2 is a schematic side elevational view of a flatbed roller press die cutter which may be used for carrying out the method of the present invention;

FIG. 3 shows an annular rotary cutting and sealing rule for use in performing the method of the present invention;

FIG. 4 is an enlarged cross sectional view through the cutting and sealing rule, as taken along line 4-4 in FIG. 3, and showing a cutting edge on one side and a sealing edge on the other side of the rule;

FIG. 5 is a perspective view of a transverse cutting and sealing rule;

FIG. 6 is a schematic cross sectional view illustrating an annular cutting and sealing operation performed on a polymeric material on a soft anvil rotary die cutter with an annular cutting and sealing rule similar to that illustrated in FIG. 3;

FIG. 7 is a schematic cross sectional view illustrating a transverse cutting and sealing operation performed on a polymeric material on a soft anvil rotary die cutter using a transverse cutting and sealing rule similar to that illustrated in FIG. 5;

FIG. 8 is a schematic cross sectional view showing a transverse cutting and sealing of a polymeric material on a flatbed roller press die cutter with a transverse cutting and sealing rule similar to that illustrated in FIG. 5; and

FIG. 9 illustrates a die cut part produced using the method of the present invention;

### DETAILED DESCRIPTION OF THE PREFERRED EMBODIMENT

The method of the present invention may be carried out on a variety of different apparatus in order to provide a simultaneously cut and sealed edge for a polymeric or fibrous material. The method is preferably carried out on a conventional soft anvil rotary die cutter which includes a pair of rotating rolls or drums between which the polymeric or fibrous material is advanced, such as is disclosed in U.S. Pat. No. 5,515,757, which is incorporated herein by reference.

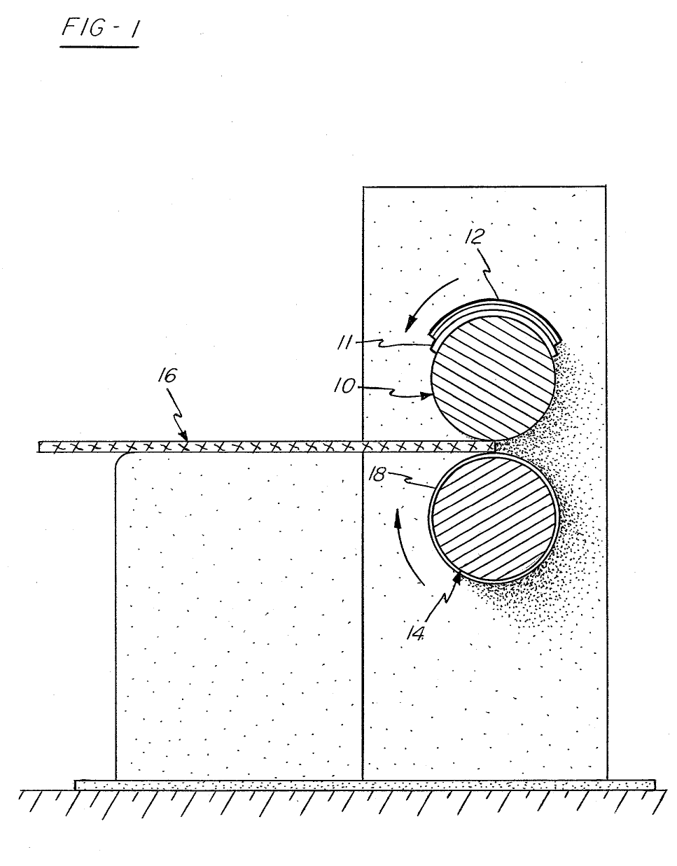

FIG. 1 illustrates a typical soft anvil rotary die cutter arrangement for carrying out the method of the present invention including a die cylinder 10 having a rotary die board 11 supporting a cutting and sealing rule 12 wherein the cutting and sealing rule 12 is configured in accordance with the principles of the present invention, as will be described further below. An anvil cylinder 14 is located adjacent to the die cylinder 10 wherein the die cylinder 10 and anvil cylinder 14 are rotated to advance a material 16 therebetween to be cut and sealed. The anvil cylinder 14 is further provided with a non-metallic cover 18, such as a cover formed of polyurethane material having a hardness of Shore 70D. The surface of the cover 18 is positioned such that it will be adjacent to and engaged by the cutting and sealing rule 12 as the cutting and sealing rule 12 passes through the material 16 to provide a complete cut of the material 16.

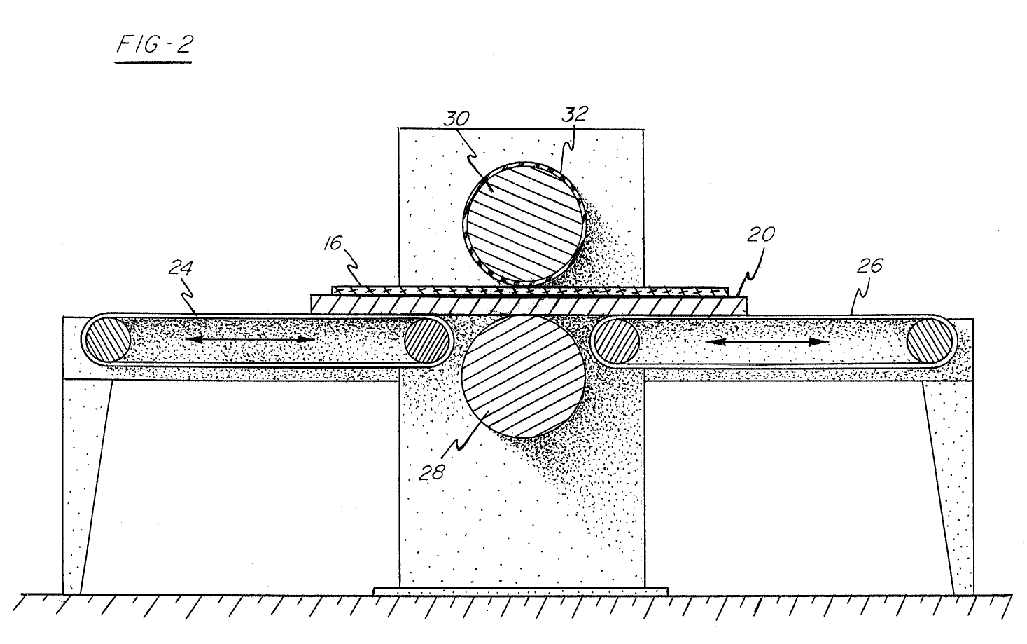

FIG. 2 illustrates an alternative cutting structure comprising a flatbed roller press die cutting system including a flat die board 20 carrying a cutting and sealing rule 22 (see also FIG. 8) wherein the die board 20 is conveyed for movement in a longitudinal direction by a pair of conveyor belts 24, 26. A pressure cylinder 28 is located between the two conveyor belts 24, 26 for cooperating with and pressing upwardly the cutting and sealing rule 22, and an anvil cylinder 30 is located above the pressure cylinder 28 and includes a non-metallic cover 32 similar to the nonmetallic cover 18 described with reference to FIG. 1.

In performing a cutting and sealing operation using the device of FIG. 2, the sheet of material 16 is supported on the die board 20 and is cut and sealed at the location of the cutting and sealing rule 22 as the die board 20 is conveyed between the pressure cylinder 28 and the anvil cylinder 30.

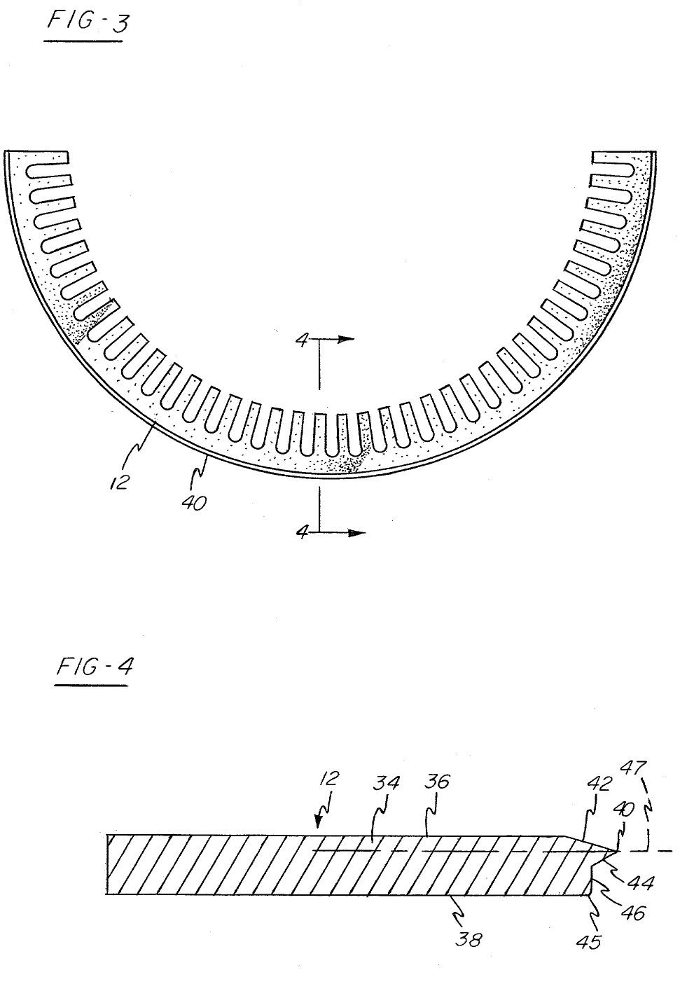

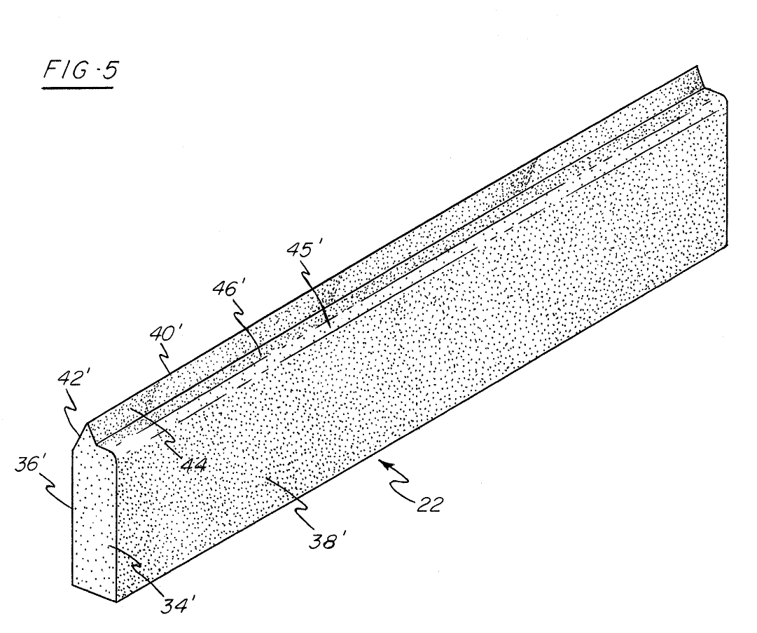

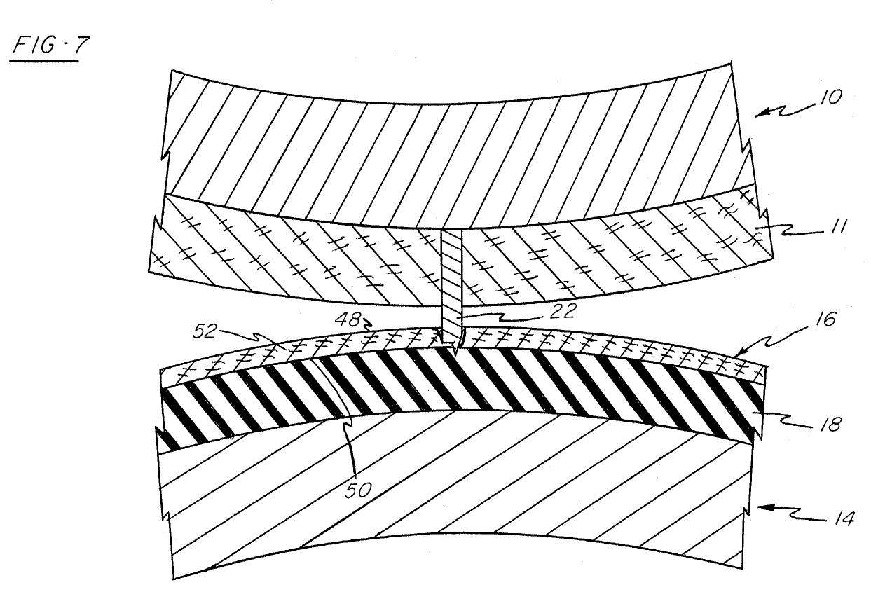

Referring to FIGS. 3, 4 and 5, two embodiments of the cutting and sealing rule of the present invention are illustrated. In FIG. 3, an annular cutting and sealing rule 12, such as in incorporated in the machine illustrated in FIGS. 1 and 6, is shown. This cutting and sealing rule 12 is designed to extend longitudinally of the direction of travel of the material 16 and comprises a main body portion 34 defining opposing sides 36, 38. The side 36 extends to a tapered cutting edge 40 along an angled portion 42. A further angled portion 44 of the cutting edge 40 extends toward a sealing surface 46 of the main body 34 and intersects the side 38 at a radiused edge 45. The sealing surface 46 extends transversely, preferably perpendicularly, relative to and extending to one side of a plane 47 extending along the height of the main body portion 34 and containing the cutting edge 40. The cutting edge 40 defines a micro-serrated cutting edge for cutting through material 16, and the sealing surface 46 defines a compression engagement surface for applying a predetermined compressive force against the material being cut.

In one operable embodiment of the invention, the distance between the opposing surfaces 36, 38 of the cutting and sealing rule 22 is 0.104″, the width of the sealing surface as measured from the side surface 38 to the intersection of the angled portion 44 and the sealing surface 46 is 0.068″, and the height of the cutting edge 40 above the sealing surface 46 is 0.035″. The particular dimensions of the cutting and sealing rule are selected with reference to the material being cut and sealed in order to ensure that the cutting and sealing rule both provides a clean cut through the material, as well as provides sufficient compressive force to the material to cause a sealing of the edge of the material. It should be noted, however, that the height of the cutting edge 40 from the sealing surface 46 must exceed the thickness of the material 16 in order to provide a complete cut of the material 16.

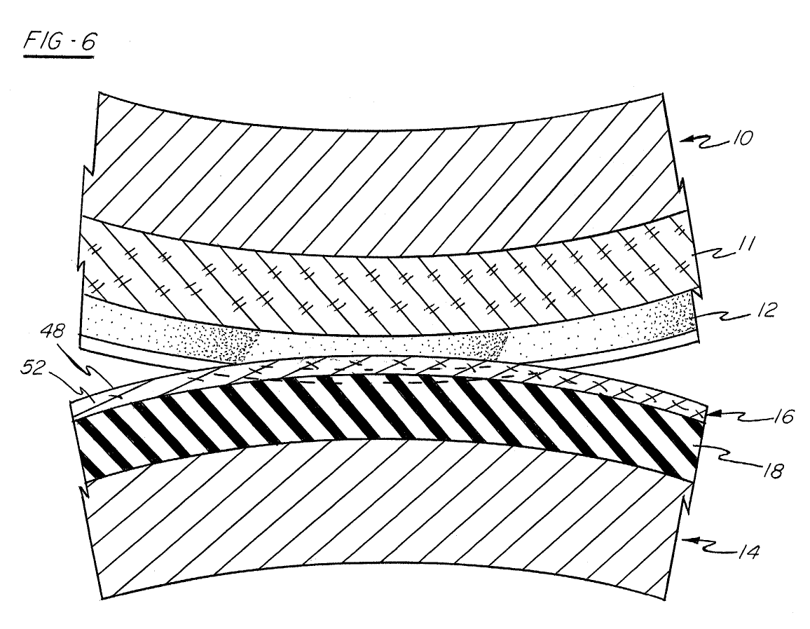

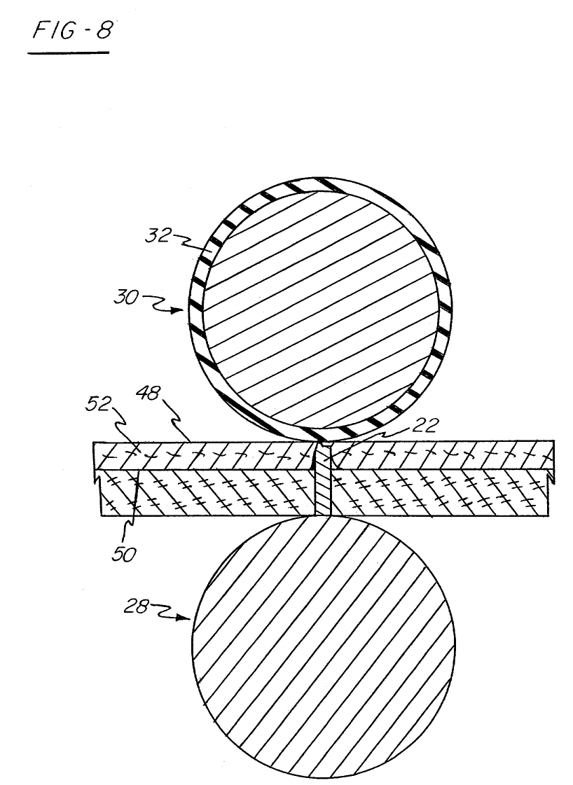

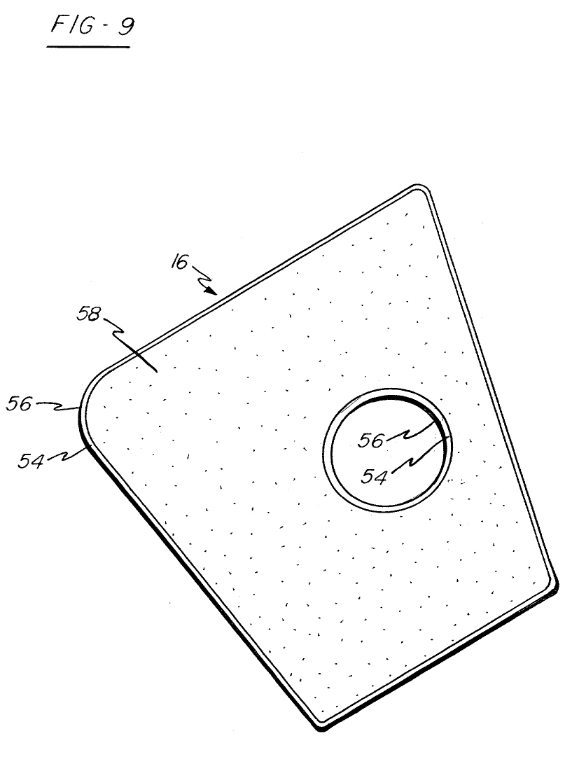

FIG. 5 illustrates the cutting and sealing rule 22 for performing a cut and seal operation in a direction transverse to the direction of travel of the material 16. The cutting and sealing rule 22 is provided with similar design characteristics to those described with reference to the cutting and sealing rule 12 of FIG. 3 wherein elements of the cutting and sealing rule 22 corresponding to elements of the cutting and sealing rule 12 are labeled with the same reference numerals primed. An operable installation of the cutting and sealing rule 22 is shown in FIGS. 7 and 8.

In accordance with the method of the present invention, a polymeric or fibrous material is operated upon by the cutting and sealing rule 12, 22 in combination with the corresponding cooperating non-metallic anvil surface 18, 32 in order to simultaneously cut the material 16 and seal the material 16 along one side of the cut edge. In particular, the method of the present invention is adapted for cutting and sealing blown filament polypropylene insulation material comprising opposing surface layers 48, 50 of polypropylene scrim and a layer of polypropylene fibers therebetween, such as is sold by Strandtek International of Chicago, Ill. As the material 16 is cut by the cutting edge 40, 40′ of the cutting and sealing rule 12, 22, the opposing scrim layers 48, 50 are pressed into engagement with each other to cause the two layers 48, 50 to be welded or sealed together in response to energy produced as a result of relative movement between the cutting and sealing rule 12, 22 and the cooperating surface 18, 32 of the anvil 14, 30. The energy produced by the relative movement of the cutting and sealing rule 12, 22 and the cooperating surface 18, 32 comprises a compressive and thermal energy sufficient to cause the two scrim layers 48, 50 to melt together and form a seam encasing the fiber layers 52 of the material 16. FIG. 5 illustrates a product produced by the present method wherein a distinct seam area 54 is produced extending inwardly from a cut edge 56 and defining a boundary between the edge 56 and the remaining area 58 of the material 16 where the opposing scrim layers 48, 50 are spaced from each other and enclose polymeric fiber.

From the above description, it should be apparent that the present invention provides a method for simultaneously cutting and sealing a material which is conducive to increasing production efficiency and reducing energy input requirements. Specifically, the present method avoids the need for external thermal energy input by utilizing the energy inherent in the movement of the cutting and sealing rule relative to the anvil surface whereby the seal area is compressed and heated simultaneously with the cutting operation to provide a clean cut edge having a sealed area formed by bonding of opposing layers of the material. Further, the present method effectively controls the width of the seam and provides a consistent seam along the length of the cut edge.

It should also be apparent that a variety of material thicknesses may be cut and sealed using the present method wherein the different material thicknesses may be accommodated by selecting an appropriate distance between the cutting edge and the sealing surface in order to ensure a full cut through the material while also ensuring sufficient compressive force to the material to form the sealed edge.

While the method herein described constitutes a preferred embodiment of this invention, it is to be understood that the invention is not limited to this precise method and that changes may be made without departing from the scope of the invention, which is defined in the appended claims.

What is claimed is:

1. A method of cutting and sealing material comprising the steps of:
providing a cutting and sealing rule defining a cutting edge and a sealing surface;
providing an anvil member adjacent and in facing relation to the cutting and sealing rule;
providing a material having at least two layers;
positioning the material between the cutting and sealing rule and the anvil member; and
operating the cutting and sealing rule to cut and seal the material to form a cut material edge and to compress the at least two layers to cause the at least two layers to adhere to each other and form a sealed edge at the cut material edge.

2. The method of claim 1 wherein the anvil member includes a compressible surface material and the cutting edge of the cutting and sealing rule engages the compressible surface material during cutting of the material.

3. The method of claim 1 wherein the sealed edge is created by energy derived from movement of the cutting and sealing rule relative to the anvil member.

4. The method of claim 1 wherein the sealed edge is a continuous seal formed simultaneously with cutting of the edge along the length of the cut edge.

5. The method of claim 4 wherein the sealed edge defines a boundary between the cut edge and an area of the at least two layers which are unattached to each other.

6. The method of claim 1 wherein the at least two layers comprise sheets of polypropylene material positioned in contact with each other at the sealed edge.

7. The method of claim 1 wherein the cutting and sealing rule is supported by a die board for a flat bed roller press die cutting system.

8. The method of claim 1 wherein the cutting and sealing rule is supported by a die cylinder of a rotary die cutting system.

9. A method of cutting and sealing blown filament polypropylene insulation material comprising opposing surface layers formed of polypropylene scrim and a panel of polypropylene fibers therebetween, the method comprising:
providing a cutting and sealing rule defining a cutting edge and a sealing surface;
providing an anvil member positioned for engagement with the cutting and sealing rule;
positioning the insulation material between the cutting and sealing rule and the anvil member; and
operating the cutting and sealing rule to cut and seal the material to form a cut material edge and to compress the opposing surface layers of the polypropylene scrim to cause the interior edges of the opposing surface layers to adhere to each other and form a sealed edge at the cut material edge.

10. The method of claim 9 wherein the anvil member comprises a compressible surface and the cutting edge of the cutting and sealing rule engages the compressible surface during cutting and sealing of the material.

11. The method of claim 9 wherein the sealed edge is created by energy derived from movement of the cutting and sealing rule relative to the anvil member.

12. The method of claim 9 wherein the sealed edge is a continuous seal formed simultaneously with cutting of the edge along the length of the cut edge.

13. The method of claim 12 wherein the sealed edge defines a boundary between the cut edge and an area of the layers of polypropylene scrim which are unattached to each other.

14. The method of claim 9 wherein the cutting and sealing rule is supported by a die board for a flat bed roller press die cutting system.

15. The method of claim 9 wherein the cutting and sealing rule is supported by a die cylinder of a rotary die cutting system.
